(19) United States
(12) Patent Application Publication
(10) Pub. No.: US 2010/0001954 A1
(43) Pub. Date: Jan. 7, 2010

(54) Computer-use mouse structure

(76) Inventors: Miguel Angel Sevilla Casbas, Zaragoza (ES); Jerry Lee Shelfer, Woodacre, CA (US)

Correspondence Address: JERRY SHELFER, POB 3, WOODACRE, CA, 94973, US

(21) Appl. No.: 12/217,475

(22) Filed: Jul. 7, 2008

(51) Int. Cl. G06F 3/033

(52) U.S. Cl. 345/163

(57) ABSTRACT

Such computer-use mouse structure changes the relative position of mouse's left key, right key and roller and increases the relative distance among them. The changes enable joints of user's hand to move more frequently. Thus user's hand will seldom suffer from fatigue. The technical design is done in this way: mouse's left key or right key and roller are set respectively at both sides of mouse shell while right key or left key are set above mouse shell. This utility model has the following advantages: based on existing technology, no additional mouse part is needed and therefore no additional manufacturing cost is produced. Only the position of left key, right key and roller is changed to enable joints of user's hand to move more frequently so as to reduce hand fatigue and increase work efficiency. It is an ideal mouse structure.

### TECHNICAL FIELD

This utility model is a kind of computer-use mouse structure with a new design in which the position of mouse keys and roller is changed.

### BACKGROUND

In the existing computer-use mouse structure, a mouse's left key, right key and roller are set above mouse shell. Since the distance among left key, right key and roller is relatively short, user's hand is easy to suffer from fatigue and joints of hand are easily injured.

### Invention Purpose

In order to overcome the above shortcomings of existing mouse technology, this utility model adopts an improved mouse structure, which changes the relative position of left key, right key and roller and increases the relative distance among them so as to enable joints of user's hand to move more frequently and reduce hand fatigue.

Technical design of this utility model: a computer-use mouse structure, including mouse shell, left key, right key and roller; left key and roller are set respectively at both sides of mouse shell while right key is set above mouse shell.

Effect of this utility model: based on existing technology, no additional mouse part is needed and therefore no additional manufacturing cost is produced. Only the position of left key, right key and roller is changed to enable joints of user's hand to move more frequently so as to reduce hand fatigue and increase work efficiency. It is an ideal mouse structure.

### ATTACHED FIGURES

FIG. 1: Diagram of utility model sample 1

FIG. 2: Left view of FIG. 1

FIG. 3: Right view of FIG. 1

FIG. 4: Diagram of utility model sample 2

FIG. 5: Right view of FIG. 4

FIG. 6: Left view of FIG. 4

FIG. 7: Diagram of utility model sample 3

FIG. 8: Right view of FIG. 7

FIG. 9: Left view of FIG. 7

FIG. 10: Diagram of utility model sample 4

FIG. 11: Left view of FIG. 10

FIG. 12: Right view of FIG. 10

In the attached figures, 1 refers to left key, 2 roller, 3 mouse shell, and 4 right key.

### SPECIFICATION

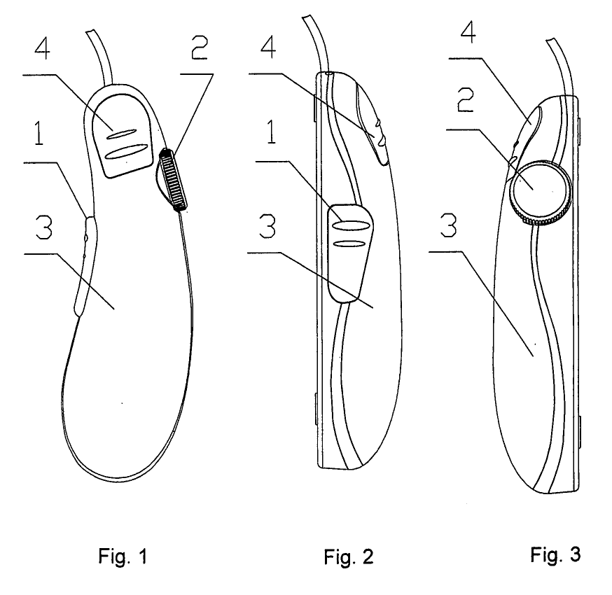

See the attached FIGS. 1-3, utility model sample 1. Existing computer-use mouse structure includes a mouse shell 3, left key 1, right key 4 and roller 2. In order to increase the distance among mouse shell 3, left key 1, right key 4 and roller 2 and enlarge the scope of hand movement at the time of using a mouse, left key 1 and roller 2 are set respectively at both sides of mouse shell 3 while right key 4 is set above mouse shell 3.

In order to meet need of user's right hand habit, utility model sample 1, left key 1 and roller 2 are set respectively on the left side and right side of mouse shell 3.

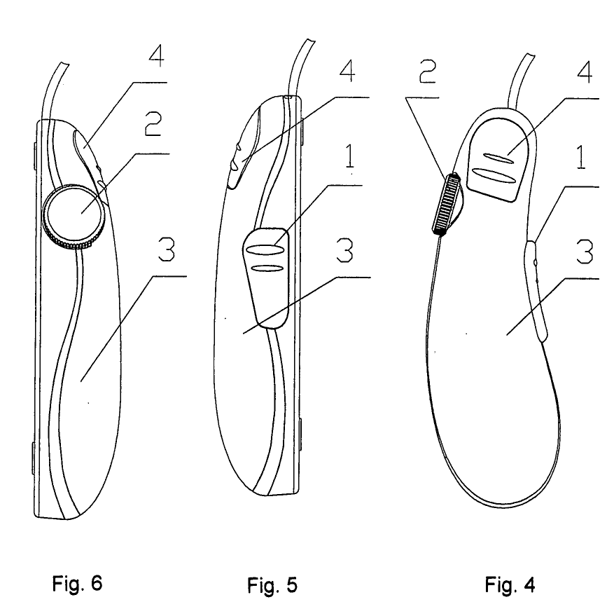

See the attached FIGS. 4-6, utility model sample 2, in order to meet need of user's left hand habit, left key 1 and roller 2 are set respectively on the right side and left side of mouse shell 3.

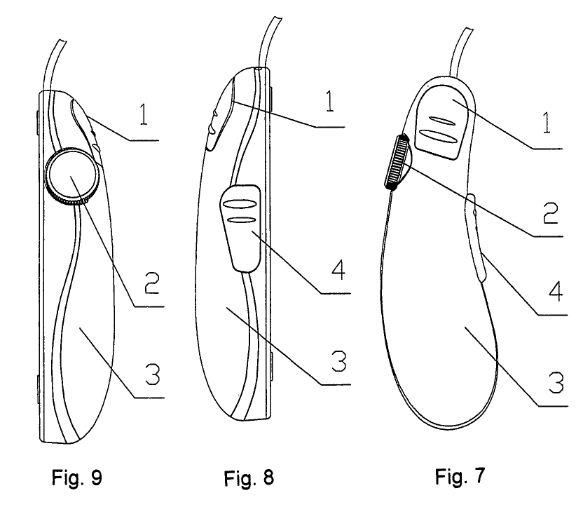

See the attached FIGS. 7-9, utility model sample 3, right key 4 and roller 2 are set respectively on the two sides of mouse shell while left key 1 is set above mouse shell 3.

In order to meet need of user's left hand habit, utility model sample 3, right key 4 and roller 2 are set respectively on the right side and left side of mouse shell 3.

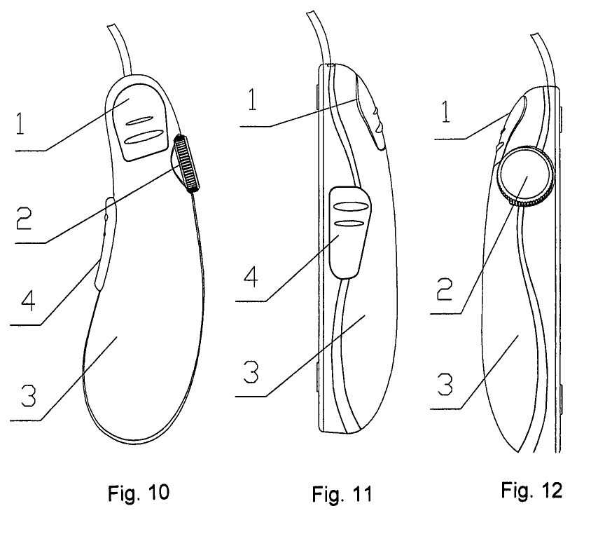

See the attached FIGS. 10-12, utility model sample 4, in order to meet need of user's right hand habit, right key 4 and roller 2 are set respectively on the left sides and right side of mouse shell 3.

In order to adapt to user's hand shape, two sides of mouse shell 3 are respectively convex-arc-shaped or concave-arc-shaped, or two sides of mouse shell 3 are respectively concave-arc-shaped or convex-are-shaped.

1. A computer-use mouse structure, including mouse shell, left key, right key and roller; features: the abovementioned left key (FIG. 1) and roller (FIG. 2) are set respectively at both sides of mouse shell (FIG. 3) while right key (FIG. 4) is set above mouse shell (FIG. 3).

2. A computer-use mouse as set forth in item 1; features: the abovementioned left key (FIG. 1) and roller (FIG. 2) are set respectively at left side and right side of mouse shell (FIG. 3).

3. A computer-use mouse structure as set forth in item 1 or 2; features: two sides of the abovementioned mouse shell (FIG. 3) are respectively convex-arc-shaped or concave-arc-shaped.

4. A computer-use mouse structure, including mouse shell, left key, right key and roller; features: the above mentioned right key (FIG. 4) and roller (FIG. 2) are set respectively at both sides of mouse shell (FIG. 3) while left key (FIG. 1) is set above mouse shell (FIG. 3).

5. A computer-use mouse as set forth in item 4; features: the above mentioned right key (FIG. 4) and roller (FIG. 2) are set respectively at right side and left side of mouse shell (FIG. 3).

6. A computer-use mouse structure as set forth in item 4 or 5; features: two sides of the abovementioned mouse shell (FIG. 3) are respectively convex-arc-shaped or concave-arc-shaped.
